(19) United States
(12) Patent Application Publication
(10) Pub. No.: US 2026/0362486 A1
(43) Pub. Date: Nov. 12, 2026

(54) METHOD AND APPARATUS FOR DEALING WITH NETWORK ALLOCATION VECTOR SETUP IN MULTI-ACCESS-POINT SYSTEM

(71) Applicant: MEDIATEK INC., Hsin-chu (TW)

(72) Inventors: Chien-Fang Hsu, Hsinchu City (TW); Hao-Hua Kang, Hsinchu City (TW)

(73) Assignee: MEDIATEK INC., Hsin-chu (TW)

(21) Appl. No.: 19/141,062

(22) PCT Filed: Dec. 21, 2023
(86) PCT No.: PCT/CN2023/140498

§ 371 Date: Jun. 19, 2025

Related U.S. Application Data
(60) Provisional application No. 63/476,988, filed on Dec. 23, 2022.
(60) Provisional application No. 63/545,215, filed on Oct. 23, 2023.

(51) Int. Cl. H04W 74/0816; H04W 16/14; H04W 60/00

(52) U.S. Cl. CPC H04W 74/0816; H04W 16/14; H04W 60/005

(57) ABSTRACT

A network allocation vector (NAV) setup method includes: after a first access point (AP) of a multi-AP (MAP) system sends a request frame to a second AP of the MAP system to indicate that the first AP intends to share transmission resources with the second AP, in response to receipt of a response frame sent from the second AP to indicate that the second AP accepts to use the transmission resources shared by the first AP, managing at least one of a basic NAV and an intra basic service set (intra-BSS) NAV of a non-AP station (STA) according to the response frame, wherein the non-AP STA is associated with one of the first AP and the second AP.

### BACKGROUND OF THE INVENTION

### 1. Field of the Invention

The present invention relates to wireless communications, and more particularly, to a method and apparatus for dealing with network allocation vector (NAV) setup in a multi-access-point (MAP) system.

### 2. Description of the Prior Art

In an MAP system, several access points (APs) form a coordination group. These APs in the same MAP system may be regarded as member APs, and can serve associated client(s) at the same time. Specifically, member APs of the same MAP system are able to share transmission resources such as transmission opportunity (TXOP) and target wake time (TWT) service period (SP), so that specific services can benefit from overlapping basic service set (OBSS) interference mitigation and predictable transmit (TX) and receive (RX) behaviors. For example, member APS of the same MAP system can perform joint transmission (JT) toward a client associated with one or more member APs in the MAP system. For another example, member APs of the MAP system can perform coordinated frequency division multiple access (FDMA) transmission, where the transmission band is shared by member APs to do concurrent (at least partially overlapped in time) and independent transmission on different subbands. For yet another example, member APs of the MAP system can perform coordinated beamforming (CBF) on the same or partially overlapped frequency band.

The NAV is a virtual carrier-sensing mechanism which limits the need for physical carrier-sensing at the air interface in order to save power. The medium access control (MAC) frame header contains a duration field that specifies the transmission time in which the wireless medium will be busy. A non-AP station (STA) listening on the wireless medium reads the duration field and sets its NAV, which is an indicator for the non-AP STA on how long it must defer from accessing the wireless medium. With the development of the IEEE 802.11 standard, two NAVs, including a basic NAV (i.e., inter-BSS NAV) and an intra-BSS NAV, are proposed, where the basic NAV is a NAV that is maintained and updated by receipt of an inter physical layer protocol data unit (inter-PPDU) or a PPDU that cannot be classified as inter-PPDU or intra-PPDU, and the intra-BSS NAV is maintained and updated by an intra-PPDU only. Thus, when two NAVs are supported by a non-AP STA, there is a need for an innovative NAV setup design to properly manage the basic NAV and the intra-BSS NAV for regulating the transmission behaviors during the sharing period in a MAP system.

### SUMMARY OF THE INVENTION

One of the objectives of the claimed invention is to provide a method and apparatus for dealing with NAV setup in an MAP system.

According to a first aspect of the present invention, an exemplary network allocation vector (NAV) setup method is disclosed. The exemplary NAV setup method includes: after a first access point (AP) of a multi-AP (MAP) system sends a request frame to a second AP of the MAP system to indicate that the first AP intends to share transmission resources with the second AP, in response to receipt of a response frame sent from the second AP to indicate that the second AP accepts to use the transmission resources shared by the first AP, managing at least one of a basic NAV and an intra basic service set (intra-BSS) NAV of a non-AP station (STA) according to the response frame, wherein the non-AP STA is associated with one of the first AP and the second AP.

According to a second aspect of the present invention, an exemplary network allocation vector (NAV) setup method is disclosed. The exemplary NAV setup method includes: after a first access point (AP) of a multi-AP (MAP) system sends a request frame to a second AP of the MAP system to indicate that the first AP intends to share transmission resources with the second AP, in response to receipt of a response frame sent from the second AP to indicate that the second AP rejects to use the transmission resources shared by the first AP, managing one of a basic NAV and an intra basic service set (intra-BSS) NAV of a non-AP station (STA) according to the response frame, wherein the non-AP STA is associated with one of the first AP and the second AP.

According to a third aspect of the present invention, an exemplary non-access-point (non-AP) station (STA) is disclosed. The exemplary non-AP STA includes a network interface circuit and a control circuit. The network interface circuit is arranged to receive a response frame sent from a second access point (AP) of a multi-AP (MAP) system to indicate that the second AP accepts to use transmission resources shared by a first AP of the MAP system after the first AP sends a request frame to the second AP to indicate that the first AP intends to share the transmission resources with the second AP. The control circuit is arranged to manage at least one of a basic network allocation vector (NAV) and an intra basic service set (intra-BSS) NAV of the non-AP STA according to the response frame, wherein the non-AP STA is associated with one of the first AP and the second AP.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication system according to an embodiment of the present invention.

FIG. 2 is a diagram illustrating a Wi-Fi system according to an embodiment of the present invention.

FIG. 3 is a diagram illustrating a first NAV setup scenario according to an embodiment of the present invention.

FIG. 4 is a diagram illustrating a second NAV setup scenario according to an embodiment of the present invention.

FIG. 5 is a diagram illustrating a third NAV setup scenario according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

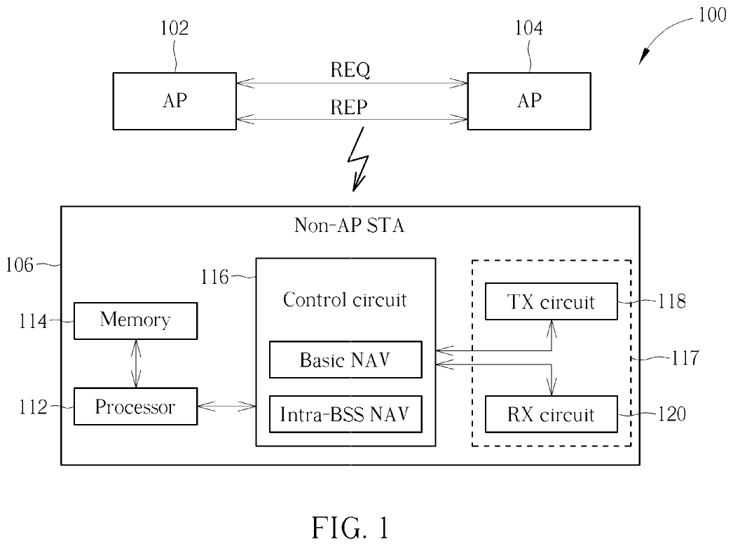

FIG. 1 is a diagram illustrating a wireless communication system according to an embodiment of the present invention. The wireless communication system 100 may be a Wi-Fi system compliant with IEEE 802.11ax standard, IEEE 802.11be standard, or a next-generation Wi-Fi standard. The wireless communication system 100 includes a plurality of APs and a plurality of non-AP STAs. For brevity and simplicity, only two APs 102, 104 and one non-AP STA 106 are illustrated in FIG. 1. In this embodiment, the APs 102, 104 are member APs of the same MAP system, and the AP 102 is a sharing AP that intends to share its transmission resources with a shared AP (e.g., AP 104). For example, the AP 102 uses a frame, such as a multi-user request to send (MU-RTS) frame, to get a TXOP or to continue an existing TXOP, and intends to share the TXOP with other AP(s) of the same MAP system. In this way, those APs can do coordination transmission such as joint transmission, coordinated FDMA, or coordinated beamforming. In the following, the terms “AP” and “member AP” may be interchangeable.

The AP 102 sends a request frame REQ to the AP 104 to indicate that the AP 102 intends to share its transmission resources to do certain coordination transmission. In response to receiving the request frame REQ, the AP 104 sends backs a response frame RSP to the AP 102 to accept or reject the sharing request issued by the AP 102. The request frame REQ can be an MU-RTS frame carrying sharing parameters. For example, the sharing parameters may include the sharing method (e.g., coordinated time division multiple access (TDMA), coordinated orthogonal frequency division multiple access (OFDMA), joint transmission, or coordinated beamforming), timing of the shared period (e.g., start time, duration, and end time), and/or the coordinated beamforming parameters (e.g., target (candidate) STA identifier (ID) and beam change needed indication). However, these are for illustrative purposes only, and are not meant to be limitations of the present invention.

The response frame RSP may be a clear to send (CTS) frame or any other response frame. The response frame RSP may carry indication that explicitly indicates whether the sharing request issued from the AP 102 is accepted or rejected by the AP 104. In an alternative design of accepting the sharing request issued from the AP 102, the action of sending the response frame RSP may implicitly indicate that the sharing request is accepted by the AP 104, if the response frame RSP is not a Contention-Free end (CF-end) frame. In an alternative design of rejecting the sharing request issued from the AP 102, the action of not sending the response frame RSP (i.e., “no transmission” of the response frame RSP) may implicitly indicate that the sharing request is rejected by the AP 104, or may indicate failed receipt of the request frame REQ. When there is no response frame RSP received from the AP 104 after the request frame REQ is sent to the AP 104, the AP 102 can use a Priority Interframe Space (PIFS) recovery procedure to access the wireless medium for follow-up transmission to intra-BSS stations. In another alternative design of rejecting the sharing request issued from the AP 102, the AP 104 may send a CF-end frame as the response frame RSP.

The non-AP STA 106 supports the proposed NAV setup scheme, and is a client that can be associated with the MAP system though coordination association. In this embodiment, the non-AP STA 106 may be associated with one of the APs 102 and 104 of the MAP system. As shown in FIG. 1, the non-AP STA 106 includes a processor 112, a memory 114, a control circuit 116, and a network interface circuit 117, where the network interface circuit 117 may be a transceiver including a TX circuit 118 and an RX circuit 120. The memory 114 is arranged to store a program code. The processor 112 is arranged to load and execute the program code to manage the non-AP STA 106. The control circuit 116 is arranged to control wireless communications with an associated AP. For example, the control circuit 116 controls the TX circuit 118 of the network interface circuit 117 to deal with uplink (UL) traffic, and controls the RX circuit 120 of the network interface circuit 117 to deal with downlink (DL) traffic.

The non-AP STA 106 is capable of maintaining two NAVs, including a basic NAV (i.e., inter-BSS NAV) and an intra-BSS NAV. In this embodiment, the non-AP STA 106 is a client associated with one AP of the MAP system. In a case where the non-AP STA 106 (particularly, RX circuit 120 of network interface circuit 117) hears the request frame REQ sent from the AP (e.g., TXOP owner) 102 to the AP 104, the control circuit 116 may manage at least one of the basic NAV and the intra-BSS NAV of the non-AP STA 106 according to the request frame REQ. In another case where the non-AP STA 106 (particularly, RX circuit 120 of network interface circuit 117) hears the response frame RSP sent from the AP 104 to the AP (e.g., TXOP owner) 102, the control circuit 116 may manage at least one of the basic NAV and the intra-BSS NAV of the non-AP STA 106 according to the response frame RSP. With proper setup of the basic NAV and the intra-BSS NAV, the transmission behaviors during the shared period in the MAP system can be well regulated. Further details of the proposed NAV setup scheme are described as below with reference to the accompanying drawings.

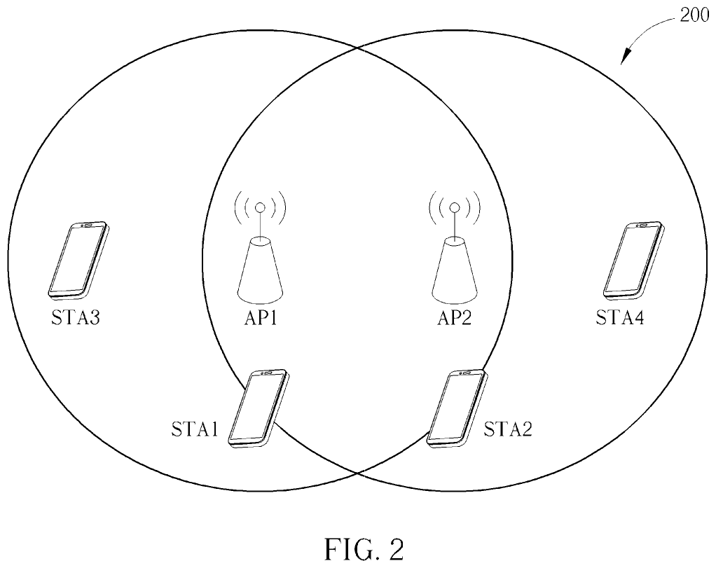

FIG. 2 is a diagram illustrating a Wi-Fi system according to an embodiment of the present invention. The Wi-Fi system 200 includes multiple APs AP1 and AP2 of the same MAP system, and further includes multiple non-AP STAs STA1, STA2, STA3, STA4. The non-AP STAs STA1 and STA3 are associated with the AP AP1. The non-AP STAs STA2 and STA4 are associated with the AP AP2. The non-AP STA STA3 is a hidden node to the AP AP2. The non-AP STA STA4 is a hidden node to the AP AP1. In the following, it is assumed that the AP AP1 may be the AP 102 shown in FIG. 1, and the AP AP2 may be the AP 104 shown in FIG. 1. That is, the AP AP1 intends to share its transmission resources with the AP AP2 to do certain coordination transmission. The non-AP STA 106 shown in FIG. 1 may be one of the non-AP STAs STA1-STA4. That is, each of the non-AP STAs STA1-STA4 supports the proposed NAV setup scheme, and may have the same circuit structure shown in FIG. 1.

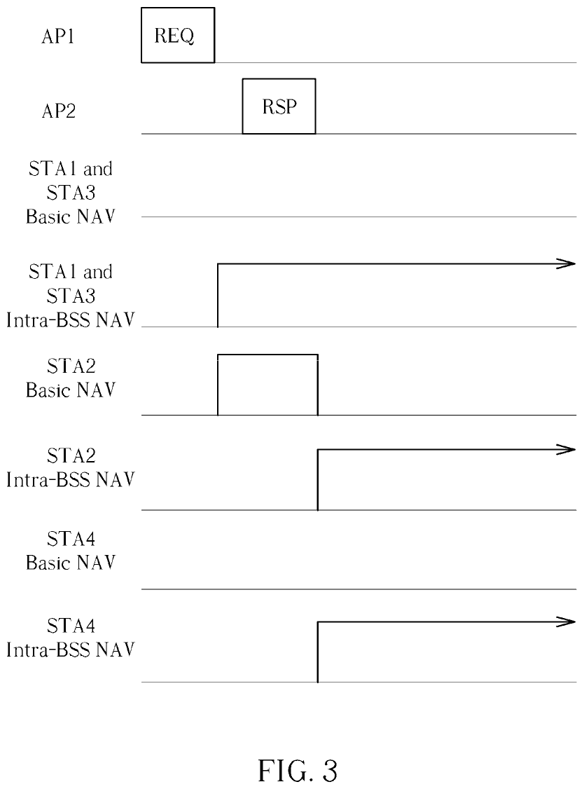

Please refer to FIG. 2 in conjunction with FIG. 3. FIG. 3 is a diagram illustrating a first NAV setup scenario according to an embodiment of the present invention. In accordance with the first NAV setup scenario, the sharing request is accepted. The AP AP1 sends the request frame REQ to the AP AP2. Since the non-AP STAs STA1 and STA3 are associated with the AP AP1, both of the non-AP STAs STA1 and STA3 can hear the request frame REQ and regard the request frame REQ as an intra-BSS frame. Hence, each of the non-AP STAs STA1 and STA3 sets up its intra-BSS NAV according to the duration information carried in the request frame REQ.

Since the non-AP STA STA2 is not a hidden node to the AP AP1, the non-AP STA STA2 can hear the request frame REQ. Since the non-AP STA STA2 is not associated with the AP AP1, the non-AP STA STA2 regards the request frame REQ as an inter-BSS frame. Hence, the non-AP STA STA2 sets up its basic NAV according to the duration information carried in the request frame REQ. Since the non-AP STA STA4 is a hidden node to the AP AP1, the non-AP STA STA4 cannot hear the request frame REQ. Hence, the non-AP STA STA4 does not set up its basic NAV.

After receiving the request frame REQ from the AP AP1, the AP AP2 sends back the response frame RSP to indicate that the AP AP2 accepts to use the transmission resources shared by the AP AP1. Since the non-AP STA STA1 is not a hidden node to the AP AP2, the non-AP STA STA1 can hear the response frame RSP. Since the response frame RSP explicitly/implicitly indicates that the AP AP2 accepts to use the transmission resources shared by the AP AP1, the non-AP STA STA1 regards AP2's transmission, including the response frame RSP, as intra-BSS. Hence, according to the response frame RSP indicative of acceptance of the sharing, the non-AP STA STA1 does not need to set up its basic NAV. Since the non-AP STA STA3 is a hidden node to the AP AP2, the non-AP STA STA3 cannot hear the response frame RSP. Hence, the non-AP STA STA3 does not need to set up its basic NAV. Specifically, since the non-AP STA STA3 can only hear the request frame REQ, the non-AP STA STA3 sets up its intra-BSS NAV only.

Since the non-AP STA STA2 is associated with the AP AP2, the non-AP STA STA2 can hear the response frame RSP. Since the response frame RSP explicitly/implicitly indicates that the AP AP2 accepts to use the transmission resources shared by the AP AP1, the non-AP STA STA2 regards AP1′ transmission as intra-BSS rather than inter-BSS. Hence, according to the response frame RSP indicative of acceptance of the sharing, the non-AP STA STA2 sets up its intra-BSS NAV, and further ceases its basic NAV that was previously set up due to the request frame REQ issued from the AP AP1. Alternatively, according to the response frame RSP, the non-AP STA STA2 sets up its intra-BSS NAV, and further ignores its basic NAV that was previously set up due to the request frame REQ issued from the AP AP1. That is, the non-AP STA STA2 may keep the basic NAV that was set up before the response frame RSP is set from the AP AP2, but will ignore it when requiring/being requested for transmission.

Since the non-AP STA STA4 is associated with the AP AP2, the non-AP STA STA4 can hear the response frame RSP. Since the response frame RSP explicitly/implicitly indicates that the AP AP2 accepts to use the transmission resources shared by the AP AP1, the non-AP STA STA4 regards AP1′ transmission as intra-BSS rather than inter-BSS. Hence, according to the response frame RSP indicative of acceptance of the sharing, the non-AP STA STA4 sets up its intra-BSS NAV. Specifically, since the non-AP STA STA4 can only hear the response frame RSP, the non-AP STA STA4 sets up its intra-BSS NAV only.

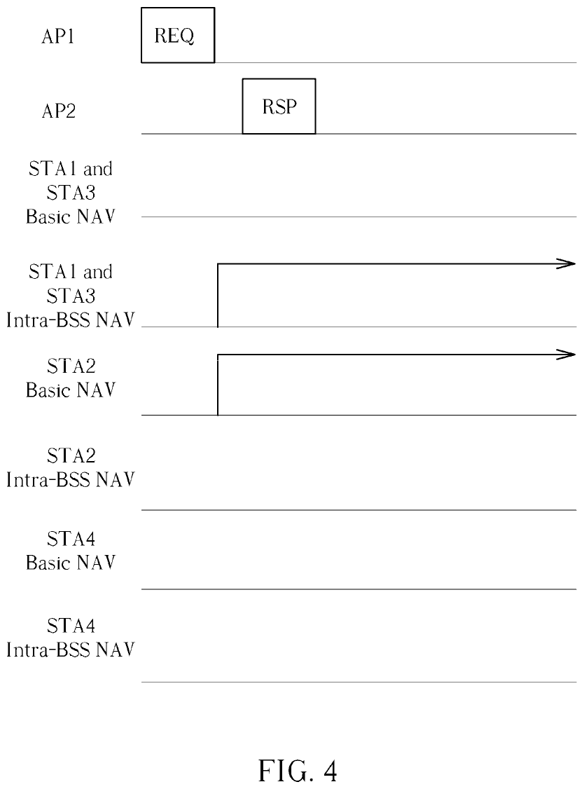

Please refer to FIG. 2 in conjunction with FIG. 4. FIG. 4 is a diagram illustrating a second NAV setup scenario according to an embodiment of the present invention. In accordance with the second NAV setup scenario, the sharing request is rejected. The AP AP1 sends the request frame REQ to the AP AP2. Since the non-AP STAs STA1 and STA3 are associated with the AP AP1, both of the non-AP STAs STA1 and STA3 can hear the request frame REQ and regard the request frame REQ as an intra-BSS frame. Hence, each of the non-AP STAs STA1 and STA3 sets up its intra-BSS NAV according to the duration information carried in the request frame REQ.

Since the non-AP STA STA2 is not a hidden node to the AP AP1, the non-AP STA STA2 can hear the request frame REQ. Since the non-AP STA STA2 is not associated with the AP AP1, the non-AP STA STA2 regards the request frame REQ as an inter-BSS frame. Hence, the non-AP STA STA2 sets up its basic NAV according to the duration information carried in the request frame REQ. Since the non-AP STA STA4 is a hidden node to the AP AP1, the non-AP STA STA4 cannot hear the request frame REQ. Hence, the non-AP STA STA4 does not set up its basic NAV.

After receiving the request frame REQ from the AP AP1, the AP AP2 sends back the response frame RSP to indicate that the AP AP2 rejects to use the transmission resources shared by the AP AP1. Since the non-AP STA STA1 is not a hidden node to the AP AP2, the non-AP STA STA1 can hear the response frame RSP. Since the response frame RSP explicitly indicates that the AP AP2 rejects to use the transmission resources shared by the AP AP1, the non-AP STA STA1 realizes that there is no AP2's transmission during the current TXOP owned by the AP AP1. Hence, according to the response frame RSP indicative of rejection of the sharing, the non-AP STA STA1 does not need to set up its basic NAV. Since the non-AP STA STA3 is a hidden node to the AP AP2, the non-AP STA STA3 cannot hear the response frame RSP. Hence, the non-AP STA STA3 does not need to set up its basic NAV. Specifically, since the non-AP STA STA3 can only hear the request frame REQ, the non-AP STA STA3 sets up its intra-BSS NAV only.

Since the non-AP STA STA2 is associated with the AP AP2, the non-AP STA STA2 can hear the response frame RSP. Since the response frame RSP explicitly indicates that the AP AP2 rejects to use the transmission resources shared by the AP AP1, the non-AP STA STA2 realizes that there is no AP2's transmission during the current TXOP owned by the AP AP1. Hence, according to the response frame RSP indicative of rejection of the sharing, the non-AP STA STA2 does not need to set up its intra-BSS NAV. Specifically, during the current TXOP owned by the AP AP1, the non-AP STA STA2 regards API's transmission as inter-BSS only.

Since the non-AP STA STA4 is associated with the AP AP2, the non-AP STA STA4 can hear the response frame RSP. Since the response frame RSP explicitly indicates that the AP AP2 rejects to use the transmission resources shared by the AP AP1, the non-AP STA STA4 realizes that there is no AP2's transmission during the current TXOP owned by the AP AP1. Hence, according to the response frame RSP indicative of rejection of the sharing, the non-AP STA STA4 does not need to set up its intra-BSS NAV. Specifically, the non-AP STA STA4 can only hear the response frame RSP, but does not set up its intra-BSS NAV.

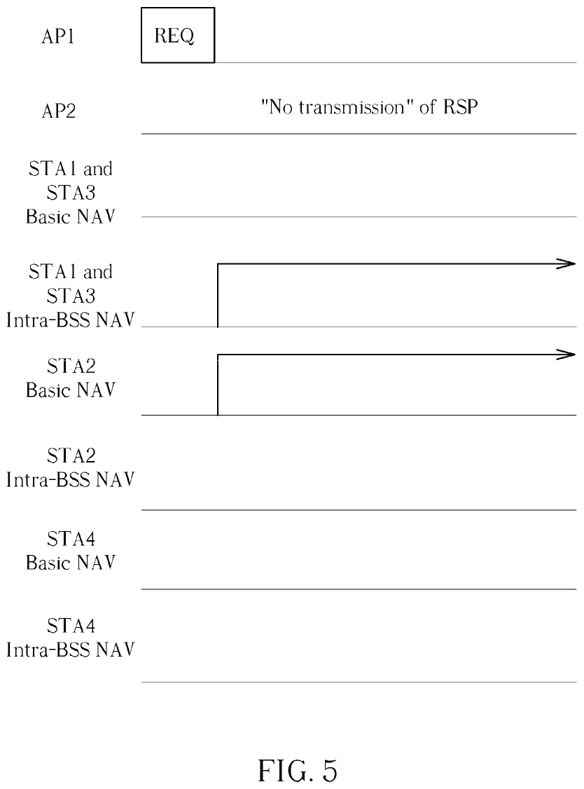

Please refer to FIG. 2 in conjunction with FIG. 5. FIG. 5 is a diagram illustrating a third NAV setup scenario according to an embodiment of the present invention. In accordance with the third NAV setup scenario, the sharing request is rejected. The difference between the third NAV setup scenario and the second NAV setup scenario is that the AP AP2 does not respond to the AP API's REQ as the indication for rejection of the sharing (or indication of failed receipt of the request frame REQ). The AP AP1 sends the request frame REQ to the AP AP2. Since the non-AP STAs STA1 and STA3 are associated with the AP AP1, both of the non-AP STAs STAI and STA3 can hear the request frame REQ and regard the request frame REQ as an intra-BSS frame. Hence, each of the non-AP STAs STA1 and STA3 sets up its intra-BSS NAV according to the duration information carried in the request frame REQ. Since the non-AP STA STA2 is not a hidden node to the AP AP1, the non-AP STA STA2 can hear the request frame REQ. Since the non-AP STA STA2 is not associated with the AP AP1, the non-AP STA STA2 regards the request frame REQ as an inter-BSS frame. Hence, the non-AP STA STA2 sets up its basic NAV according to the duration information carried in the request frame REQ. Since the non-AP STA STA4 is a hidden node to the AP AP1, the non-AP STA STA4 cannot hear the request frame REQ. Hence, the non-AP STA STA4 does not set up its basic NAV. After receiving the request frame REQ from the AP AP1, the AP AP2 does not send back a response frame. Since no response frame from the AP AP2 can be received by any of the non-AP STAs STA1-STA4, there is no response frame introduced change made to any of the basic NAV and the intra-BSS NAV.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network allocation vector (NAV) setup method comprising:
after a first access point (AP) of a multi-AP (MAP) system sends a request frame to a second AP of the MAP system to indicate that the first AP intends to share transmission resources with the second AP,
in response to receipt of a response frame sent from the second AP to indicate that the second AP accepts to use the transmission resources shared by the first AP, managing at least one of a basic NAV and an intra basic service set (intra-BSS) NAV of a non-AP station (STA) according to the response frame, wherein the non-AP STA is associated with one of the first AP and the second AP.

2. The NAV setup method of claim 1, wherein the non-AP STA is associated with the first AP.

3. The NAV setup method of claim 2, wherein managing at least one of the basic NAV and the intra-BSS NAV of the non-AP STA according to the response frame comprises:
according to the response frame, not setting up the basic NAV.

4. The NAV setup method of claim 1, wherein the non-AP STA is associated with the second AP.

5. The NAV setup method of claim 4, further comprising:
in response to receipt of the request frame sent from the first AP, setting up the basic NAV.

6. The NAV setup method of claim 5, wherein managing at least one of the basic NAV and the intra-BSS NAV of the non-AP STA according to the response frame comprises:
according to the response frame, setting up the intra-BSS NAV and ceasing the basic NAV.

7. The NAV setup method of claim 5, wherein managing at least one of the basic NAV and the intra-BSS NAV of the non-AP STA according to the response frame comprises:
according to the response frame, setting up the intra-BSS NAV, and ignoring the basic NAV.

8. The NAV setup method of claim 4, wherein managing at least one of the basic NAV and the intra-BSS NAV of the non-AP STA according to the response frame comprises:
according to the response frame, setting up the intra-BSS NAV.

9. A network allocation vector (NAV) setup method comprising:
after a first access point (AP) of a multi-AP (MAP) system sends a request frame to a second AP of the MAP system to indicate that the first AP intends to share transmission resources with the second AP,
in response to receipt of a response frame sent from the second AP to indicate that the second AP rejects to use the transmission resources shared by the first AP, managing one of a basic NAV and an intra basic service set (intra-BSS) NAV of a non-AP station (STA) according to the response frame, wherein the non-AP STA is associated with one of the first AP and the second AP.

10. The NAV setup method of claim 9, wherein the non-AP STA is associated with the first AP.

11. The NAV setup method of claim 10, wherein managing one of the basic NAV and the intra-BSS NAV of the non-AP STA according to the response frame comprises:
according to the response frame, not setting up the basic NAV.

12. The NAV setup method of claim 9, wherein the non-AP STA is associated with the second AP.

13. The NAV setup method of claim 12, further comprising:
in response to receipt of the request frame sent from the first AP, setting up the basic NAV.

14. The NAV setup method of claim 13, wherein managing one of the basic NAV and the intra-BSS NAV of the non-AP STA according to the response frame comprises:
according to the response frame, not setting up the intra-BSS NAV.

15. The NAV setup method of claim 12, wherein managing one of the basic NAV and the intra-BSS NAV of the non-AP STA according to the response frame comprises:
according to the response frame, not setting up the intra-BSS NAV.

16. A non-access-point (non-AP) station (STA) comprising:
a network interface circuit, arranged to receive a response frame sent from a second access point (AP) of a multi-AP (MAP) system to indicate that the second AP accepts to use transmission resources shared by a first AP of the MAP system after the first AP sends a request frame to the second AP to indicate that the first AP intends to share the transmission resources with the second AP; and
a control circuit, arranged to manage at least one of a basic network allocation vector (NAV) and an intra basic service set (intra-BSS) NAV of the non-AP STA according to the response frame, wherein the non-AP STA is associated with one of the first AP and the second AP.

17. The non-AP STA of claim 16, wherein the non-AP STA is associated with the first AP.

18. The non-AP STA of claim 17, wherein according to the response frame, the control circuit does not set up the basic NAV.

19. The non-AP STA of claim 16, wherein the non-AP STA is associated with the second AP.

20. The non-AP STA of claim 19, wherein according to the response frame, the control circuit sets up the intra-BSS NAV.
